(19) United States
(12) Patent Application Publication
(10) Pub. No.: US 2013/0087752 A1
(43) Pub. Date: Apr. 11, 2013

(54) AIR LIFT JACK WITH JACK LOCKING MECHANISM

(71) Applicants: Michael Tallman, Redondo Beach, CA (US); Matthew Flournoy, South Bend, IN (US)

(72) Inventors: Michael Tallman, Redondo Beach, CA (US); Matthew Flournoy, South Bend, IN (US)

(73) Assignee: NORCO INDUSTRIES, INC., Compton, CA (US)

(21) Appl. No.: 13/269,777

(22) Filed: Oct. 10, 2011

(51) Int. Cl. B66F 3/30

(52) U.S. Cl. 254/93 H

(57) ABSTRACT

A lift jack includes a base assembly, a base support portion extending from the base assembly, air lift cylinder assembly engaging the base support portion, and a jack locking mechanism. The base support portion has at least one mechanical stop. The locking mechanism is securedly connected to the base assembly and has an adjustable extending member for engaging the at least one mechanical stop.

### BACKGROUND

Jacks for stabilizing and/or elevating vehicles are generally known. One type of jack is an air lift jack. Air lift jacks often have lifting capacities ranging above one ton and are thus often used to lift large vehicles.

Large vehicles, such as trucks, Recreational Vehicles (RVs), and the like, are lifted by air lift jacks having lifting arms or lifting saddles extending from the main body jack. When the load supported by such a jack is quickly removed from the lifting arms or lifting saddles the air lift jack has the potential for dynamic movement if not properly secured.

### SUMMARY

This invention relates in general to lift jacks and more specifically to an air lift jack including a jack locking mechanism.

In at least one embodiment, the air lift jack includes a base assembly supporting a base support portion having a vertically extending post with at least one stop securedly connected thereto. An air lift cylinder assembly is slideably engaged with the vertically extending post of the base support portion. A locking mechanism is secured to the base assembly. The locking mechanism includes an adjustable locking member securedly connected to a handle assembly. The adjustable locking member extends engages the at least one stop.

Various aspects will become apparent to those skilled in the art from the following detailed description and the accompanying drawings.

### BRIEF DESCRIPTION OF THE DRAWINGS

FIG. 1 is a perspective view of an air lift jack having a jack locking mechanism.

FIG. 2 is an enlarged view of a lower portion of the air lift jack of FIG. 1 from another perspective.

FIG. 3 is an exploded view of the locking mechanism of the air lift jack of FIG. 1.

FIG. 4 is a perspective view of the lower portion of the air lift jack of FIG. 1 showing the jack locking mechanism in an engaged position.

FIG. 5 is a perspective view of the lower portion of the air lift jack of FIG. 1 showing the jack locking mechanism in an unengaged position.

FIG. 6 is a flow chart of a method of using the air lift jack of FIG. 1.

### DETAILED DESCRIPTION

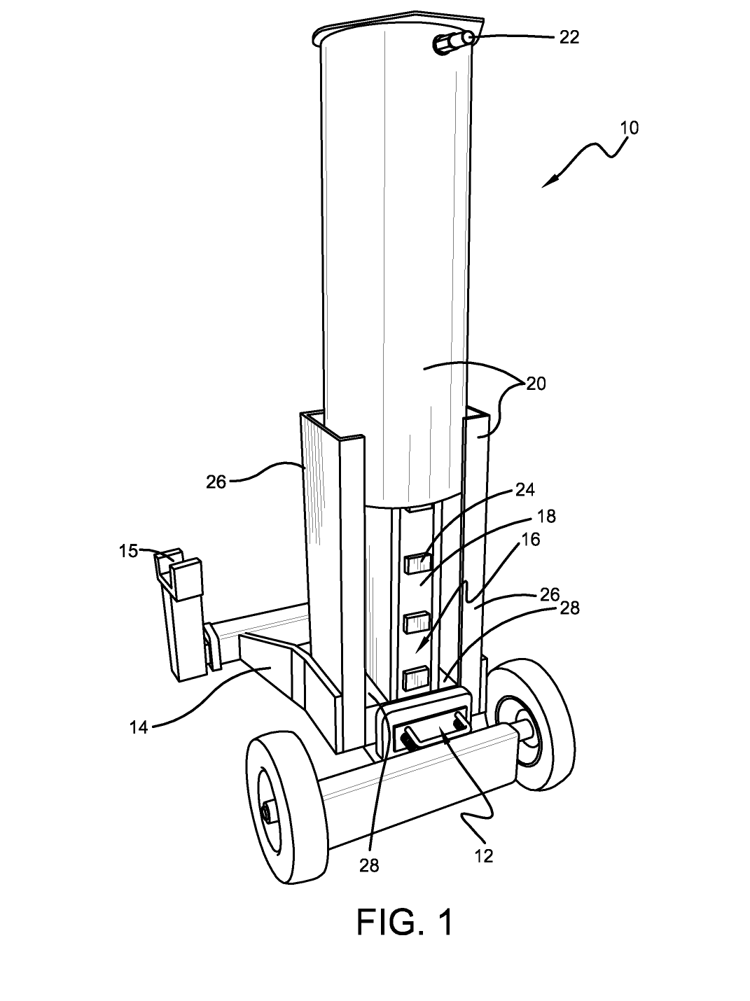

There is illustrated in FIG. 1 an air lift jack 10 having a jack locking mechanism 12. The air lift jack 10 includes a base assembly 11. In the illustrated example, the base assembly 11 includes optional wheels 13 to facilitate movement of the air lift jack 10.

A base support portion 16 is securedly attached to the base assembly 11 and includes a generally vertically extending post 18. An air lift cylinder assembly 20 engages the post 18 of the base support portion 16. The air lift cylinder assembly 20 may include an internal air assembly (not shown), although such is not required.

Two generally vertical support members, such as c-channels 26, extending downward from and are securedly connected to the air lift cylinder 20. A pair support arms extend generally horizontally from the c-channels 26. An adjustable saddle assembly 15 is securedly connected to the support arms 14. As illustrated the saddle assembly 15 extends substantially perpendicular to the support arms 14, although such is not required, and may accommodate a variety of different vehicle mounting locations.

Internal guides 28 are connected to the c-channels 26 proximate the post 18 opposite the cylinder assembly 20 on each lateral side of the post 18. The internal guides 28 slideably engage the post 18 of the base support portion 16 such that as pressure builds in the air lift cylinder assembly 20 through supply of gas or air thought a valve or fitting 22 and the cylinder assembly 20 rises relative to the post 18 the guides 28 guide the movement of the c-channels 26 and thus the arms 14 and saddle assembly 15 relative to the post 18.

In the illustrated embodiment, the base support portion 16 includes a plurality of stops 24. The stops 24 are shown as mechanical stops 24 vertically spaced from each other on one side of the post 18. In the illustrated example, each stop 24 is a rectangular portion of metal that longitudinally extends away from the post 18 towards the jack locking mechanism 12, although the stops may be of any suitable shape to engage the locking mechanism 12 as will be further described below. For example, each stop 24 may be about a half inch to about two inches in longitudinal length and securedly connected, e.g., welded, monolithically formed or otherwise formed or joined together, to the post 18, for example, at about five inch increments.

In another embodiment, each stop 24 may be securedly fastened to the vertically extending post with a counter sunk screw or other suitable fastener. In yet another embodiment, the plurality of stops 24 may be vertically spaced at a distance greater than or less than five inches, e.g., spaced at a distance about equal to the height of the adjustable locking member (discussed below), or more. In another embodiment, each stop has a square shape, a partial circular shape, or any suitable shape. In yet another embodiment, at least one stop may adjustably extend longitudinally from the vertically extending post. In another embodiment, the vertically extending post has another cross section, e.g., a circular cross section, and each stop has a corresponding surface that is securedly fastened to at least one side or portion of the vertically extending post.

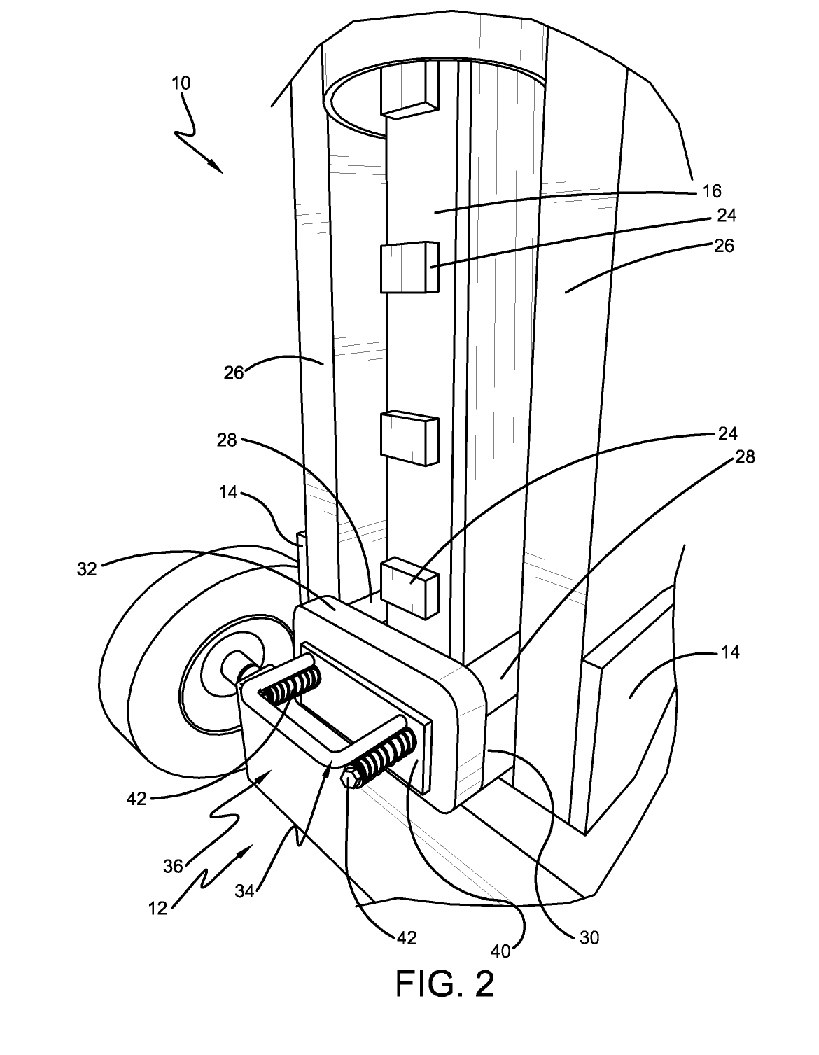

As best shown in FIG. 2, the jack locking mechanism 12 is securedly attached to the internal guides 28 by at least one weld 30, or may alternatively or additionally be attached by any suitable fastener or fastening arrangement. In another embodiment, the internal guides 28 are configured as a part of the locking mechanism that is securedly connected to a portion of the jack 10 such as the post 18. In the illustrated embodiment, the jack locking mechanism 12 includes a vertically extending base 32 securedly attached by the at least one weld 30 to each internal guide 28 in at least one location. For example, weld 30 may run along at least one vertical surface and/or at least one horizontal surface of an interface between each internal guide 28 and the vertically extending base 32. In another embodiment, the vertically extending base 32 may include more than one vertically extending portion, e.g., two smaller vertically extending bases may be laterally connected and may each securedly connect to one internal guide 28. In another embodiment, the locking mechanism 12 may be used in a device that moves in another direction other than vertical, therefore, the reference to vertical and/or horizontal should not be construed as limiting, e.g., the vertically extending base 32 may be configured to be a horizontal extending base and/or the air lift cylinder assembly 20 may have a horizontal configuration.

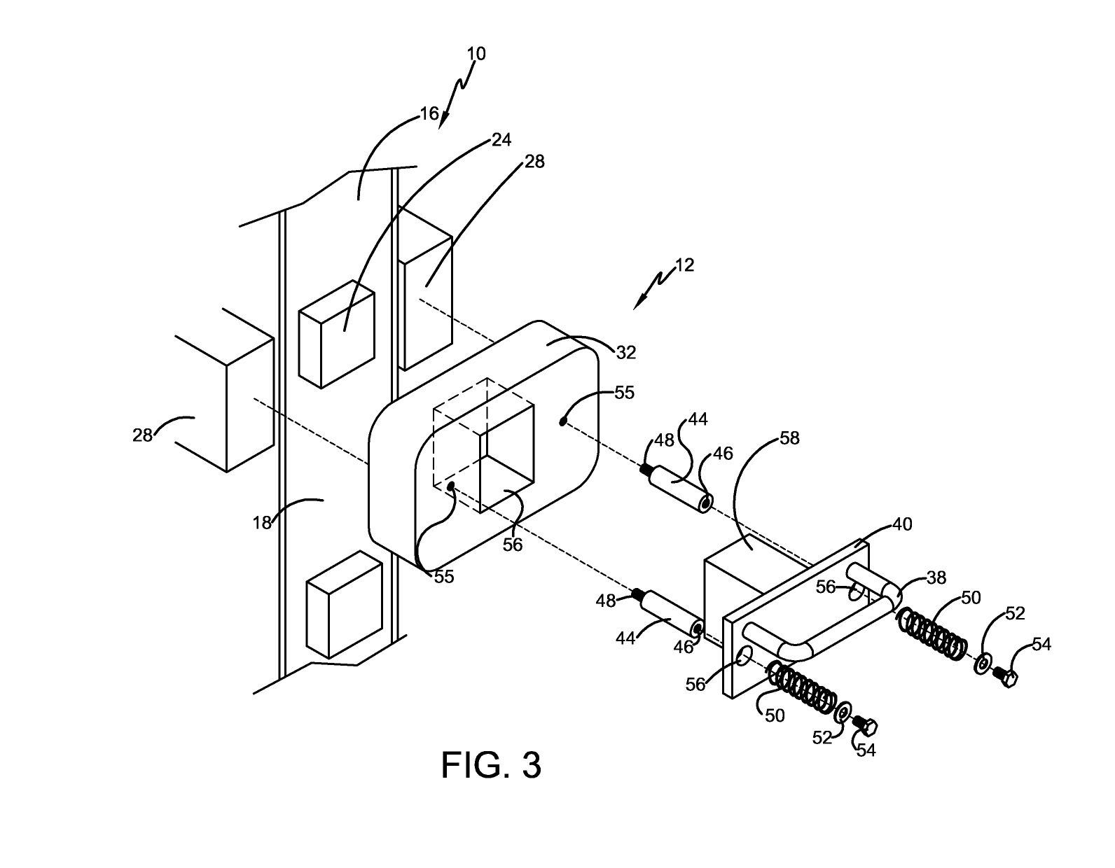

As best shown in FIGS. 2 and 3, the illustrated jack locking mechanism 12 further includes an adjustable locking member 36 having a handle assembly 34 including a u-shaped handle 38 securedly connected to a base plate 40.

As illustrated, the handle assembly 36 may be securedly connected to the vertically extending base 32 by two fastener assemblies 42. In another embodiment, not shown, the handle 38 may be welded to the base plate 40 in at least one or more locations.

In particular, FIG. 3 illustrates an exploded view of one embodiment of the jack locking mechanism 12. Each fastener assembly 42 includes a first fastener 44 having a non-threaded external portion, a female threaded end 46, and a male threaded end 48. Further, each fastener assembly 42 includes a biasing means, such as biasing spring 50, a washer 52, and a second fastener 54. The non-threaded external portions having female threaded ends 46 pass through apertures 56 in the base plate 42 allowing the base plate 42 to adjustably move relative to the first fastener 44. The male threaded ends 48 of the first fasteners 44 securedly connect to threaded apertures 55 in the vertically extending base 32. Each biasing spring 50 is retained between the base plate 40 and the washer 52 by a head of the second fastener 54 that is securedly connected to the female threaded end 46 of the first fastener 44. The spring 50 biases the locking mechanism towards the vertically extending post 18. In another embodiment, the first fastener 44 may be welded to the vertically extending base 32 and may include a fixed head or washer to retain the biasing spring. In yet another embodiment, the jack locking mechanism includes more or less fastener assemblies than what is illustrated in FIGS. 1-5. In another embodiment, the jack locking mechanism may include other types of fasteners, including but not limited to rivets and other types of nuts and bolts. In another embodiment, at least one first fastener is replaced with a post that extends from the base plate. In another embodiment, the jack locking mechanism includes a biasing means, e.g., a hydraulic or electric apparatus or actuator that has a fastening means that extends through at least one portion of the adjustable locking mechanism or the handle assembly and securedly connects to the vertically extending base. In yet another embodiment, the hydraulic or electric apparatus includes a control system that controls movement of the adjustable locking member relative to the vertically extending post of the base support portion.

In the illustrated embodiment of FIG. 3, the vertically extending base 32 of the jack locking mechanism 12 includes a square cross section aperture 56 configured to slideably receive a square cross section adjustable locking member 58 longitudinally extending from the base plate 40. In another embodiment, the aperture in the vertically extending base and the adjustable locking member have another cross section, including but not limited to circular, D-shaped, rectangular, triangular, or the like.

In the illustrated embodiment, the square adjustable locking member 58 may be adjustably positioned below any one of the stops 24 on the vertically extending post 18 of the base support portion 16 to prevent upward movement between the air lift cylinder assembly and the base support portion, e.g., when a load is unexpectedly removed from the lift. In another embodiment, the adjustable locking member 58 may include a cavity that has a corresponding shape that securedly engages a perimeter of the stop. In yet another embodiment, the stop may include a cavity that has a corresponding shape that receives and securedly engages a perimeter of the adjustable locking member. In another embodiment, the jack locking mechanism may include more than one adjustable locking member that may be configured to be adjustably positioned below more than one of the stops. In yet another embodiment, the stops are vertically spaced on the post so that the adjustable locking member may be adjustably positioned just below one stop and just above a second stop to prevent upward and downward movement between the air lift cylinder assembly and the base support portion.

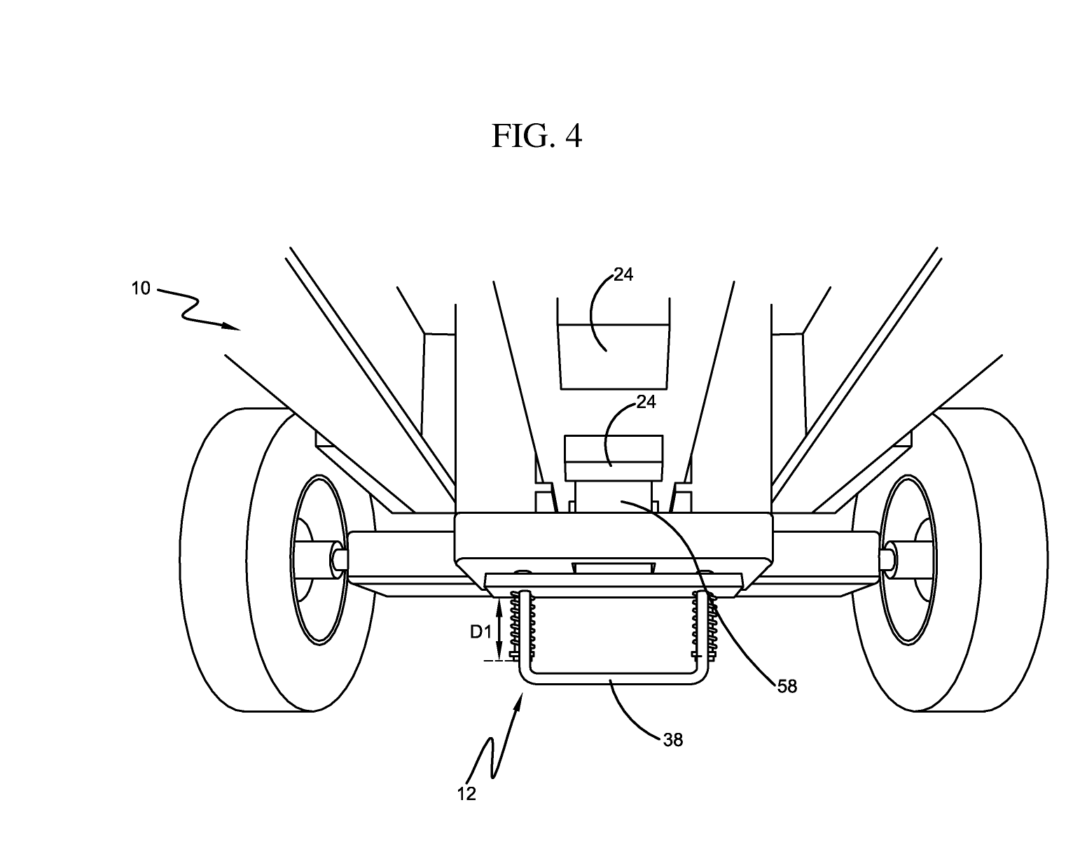

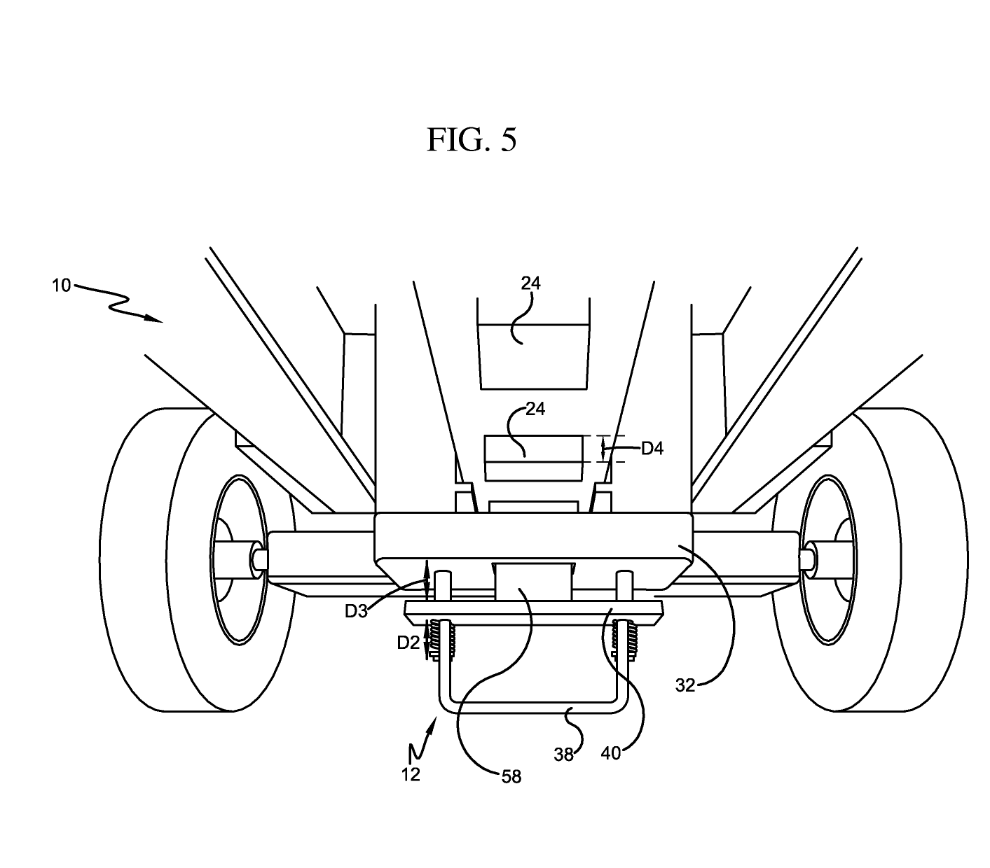

FIG. 4 illustrates the jack locking mechanism 12 engaged with a stop 24 on the lower portion of the air lift jack 10 preventing upward movement and FIG. 5 illustrates the jack locking mechanism 12 pulled back or unengaged with the stop 24 so the jack locking mechanism can be repositioned. In another embodiment, the jack locking mechanism includes a handle lock that may be used to lock the mechanism in an engaged or unengaged position. In FIG. 4, the adjustable locking member 58 of the jack locking mechanism longitudinally extends below stop 24 and is biased or urged to stay in an engaged position with the stop 24 by the two biasing springs 50 that are compressed to a first distance D1. In FIG. 5, the adjustable locking member 58 of the jack locking mechanism does not extend below stop 24 when u-shaped handle 38 is pulled away from the vertically extending post 18 of the base support portion 16. When the u-shaped handle 38 is longitudinally pulled away from the vertically extending post 18, the two biasing springs 50 compress to a second distance D2 and a gap of a third distance D3 forms between the vertically extending base 32 and the base plate 40. The jack and locking mechanism may be adjusted when the third distance D3 is greater than a fourth distance D4 that the stop 24 extends from the vertically extending post 18. In another embodiment, the distances D1-D4 may be distances greater than or less than the distances illustrated in FIGS. 4-5.

At least one locking mechanism 12 may be used on an air lift jack, for example, to prevent the jack from extending to a full stroke when a load, e.g., a vehicle, supported by the jack is suddenly removed from the jack. Similarly, the locking mechanism locks the jack in an elevated position to prevent the jack from falling downward.

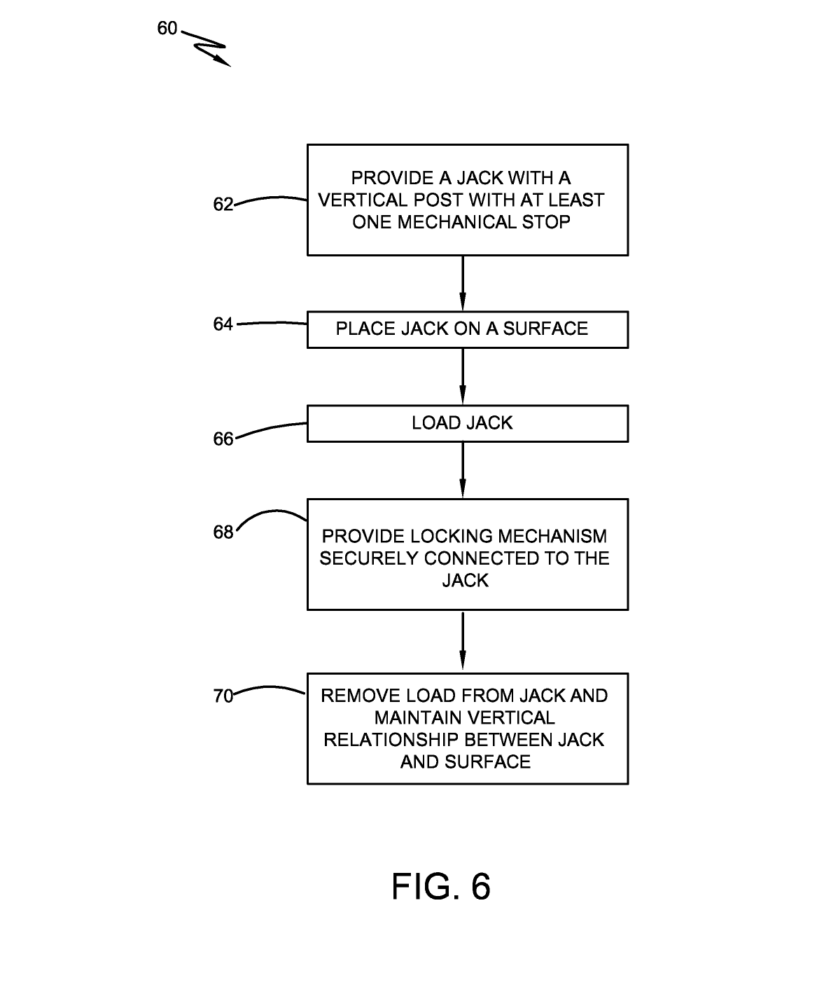

FIG. 6 is a flow chart illustrating, for example only, one embodiment of a method 60 using a jack locking mechanism 12. As shown in FIG. 6, an operator provides a jack with a vertical extending post with at least one mechanical stop at 62 and places the jack on a surface at 64. At 66, the jack is loaded and at 68 a locking mechanism is provided that is securedly connected to the jack. At 70, the load is removed from the jack so that the vertical relationship between the jack and the surface that the jack rests on is maintained within acceptable limits. For example, the vertical relationship may be considered maintained when the vertical relationship between the jack and the surface does not exceed more than twelve inches. In another embodiment, a jack saddle and at least one attachment are provided and affixed to the jack during loading and/or unloading. For example, the at least one attachment may include an air valve assembly, controls, and/or the like.

While principles and modes of operation have been explained and illustrated with regard to particular embodiments, it must be understood, however, that this may be practiced otherwise than as specifically explained and illustrated without departing from its spirit or scope.

What is claimed is:

1. An air lift jack comprising:
a base support portion including a vertically extending post with at least one stop securedly connected thereto;
a base assembly supporting the base support portion;
a cylinder assembly slideably engaged with the base support portion; and
a locking mechanism secured to the cylinder assembly and including an adjustable locking member operatively connected to a handle assembly for engaging the at least one stop.

2. The air lift jack of claim 1 further comprising at least one guide proximate the post and connected to the locking mechanism.

3. The air lift jack of claim 2 further comprising at least one c-channel connected to the at least one guide and connected to the cylinder assembly.

4. The air lift jack of claim 2 where the locking mechanism further includes a vertically extending base securedly connected to the at least one guide with the handle assembly is securedly connected to the vertically extending base, and where the adjustable locking member extends through the vertically extending base and adjustably engages the at least one stop.

5. The air lift jack of claim 1, wherein the at least one stop extends longitudinally away from the vertically extending post and the adjustable locking member longitudinally extends from the handle assembly and towards the vertically extending post, preventing vertical movement between the air lift cylinder assembly and the base support portion when in an engaged state.

6. The air lift jack of claim 1 further comprising at least two at least partially threaded bolts that extend through the handle assembly and securedly connect to the vertically extending base.

7. The air lift jack of claim 1 where the locking mechanism further includes a biasing mechanism that biases the adjustable locking member toward the vertically extending post.

8. The air lift jack of claim 7 where the locking mechanism further includes a vertically extending base plate connect to the handle and where the biasing mechanism includes at least two springs engaging the vertically extending base plate.

9. The air lift jack of claim 1, where the at least one stop is welded to the vertically extending post.

10. The air lift hack of claim 4 apparatus of claim 1, wherein the vertically extending base of the locking mechanism is welded to the least one guide.

11. A jack with a jack locking mechanism comprising:
a base support portion having a vertical member having at least one mechanical stop;
an air lift cylinder assembly engaging the vertical member; and
a locking mechanism including an adjustable extending member that adjustably engages the at least one mechanical stop, where the locking mechanism is securedly connected to the air lift cylinder assembly.

12. The jack of claim 11, where the at least one mechanical stop extends from the vertical member towards the adjustable extending member.

13. The jack of claim 11, where the locking mechanism further includes a vertically extending base and a handle assembly, where the adjustable extending member extends from the handle assembly and through the vertically extending member.

14. The jack locking mechanism of claim 13, where the vertically extending base of the locking mechanism is welded to at least one portion of the air lift cylinder assembly.

15. The jack of claim 11, wherein the locking mechanism includes a biasing means that biases the adjustable extending member towards the vertically extending member of the base support portion.

16. The jack of claim 15, wherein the biasing means includes at least one spring.

17. A method of using an air lift jack comprising:
providing a jack including a base support portion having a vertical member with at least one mechanical stop, an air lift cylinder assembly engaging the vertical member, and a locking mechanism connected to the air lift cylinder assembly and including an adjustable extending member engaging the at least one mechanical stop;
loading the jack; and
removing the load from the jack and generally maintaining a vertical relationship between the air lift cylinder and the base support portion.
